(19) United States
(12) Patent Application Publication
(10) Pub. No.: US 2026/0044266 A1
(43) Pub. Date: Feb. 12, 2026

(54) CONTROLLER, STORAGE DEVICE AND COMPUTING SYSTEM

(71) Applicant: SK hynix Inc., Gyeonggi-do (KR)

(72) Inventors: Bu Yong SONG, Gyeonggi-do (KR); Eun Ju YOON, Gyeonggi-do (KR); Dong Hyun CHO, Gyeonggi-do (KR)

(21) Appl. No.: 19/051,166

(22) Filed: Feb. 12, 2025

(30) Foreign Application Priority Data
Aug. 8, 2024 (KR) 10-2024-0105935

(51) Int. Cl. G06F 3/06

(52) U.S. Cl. CPC G06F 3/0619; G06F 3/0634; G06F 3/0659; G06F 3/0673

(57) ABSTRACT

A storage device loads mapping data into a host memory of a host device, generates recovered mapping data corresponding to the mapping data loaded into the host memory using journal data inside the storage device depending on an operation mode, and performs a background operation inside the storage device using the recovered mapping data. Therefore, delay in entering an operation mode due to access between the host device and the storage device may be reduced, and operational performance of a system including the storage device and the host device may be improved.

### CROSS-REFERENCE TO RELATED APPLICATION

The present application claims priority under 35 U.S.C. § 119(a) to Korean Patent Application No. 10-2024-0105935 filed on Aug. 8, 2024, which is incorporated herein by reference in its entirety.

### BACKGROUND

### 1. Technical Field

Various embodiments of the present disclosure generally relate to a controller, a storage device and a computing system.

### 2. Related Art

A storage device may include at least one memory which stores data. The storage device may include a controller which controls the operation of the at least one memory.

The controller may control the operation of the memory, for example, based on a command received from a host device. The host device may transmit, to the storage device, a command which requests an operation of writing data to the memory or reading data written to the memory.

In addition, the host device may transmit, to the storage device, a command which requests the storage device to operate in a low power mode to reduce power consumption. The storage device needs to efficiently operate to effectively reduce power consumption in the low power mode.

### SUMMARY

Various embodiments of the present disclosure are directed to providing measures capable of reducing an unnecessary operation and a delay when switching the operation mode of a storage device, thereby facilitating switching of the operation mode, and capable of reducing power consumption depending on the operation mode.

In an embodiment of the present disclosure, a storage device may include a memory including a plurality of storage blocks, and configured to store mapping data indicating a correspondence relationship between a logical address by a host device and a physical address associated with each of the plurality of storage blocks; and a controller configured to, in a first operation mode, load at least a part of the mapping data into a host memory located in the host device and generate journal data according to update of the mapping data loaded into the host memory, and in a second operation mode, generate recovered mapping data corresponding to the mapping data loaded into the host memory using the mapping data and the journal data stored in the memory and control a data movement operation to be performed inside the memory, based on the recovered mapping data.

In an embodiment of the present disclosure, a controller may include a sub memory; and a control circuit configured to, in a first operation mode, load mapping data stored in a first memory located externally into the sub memory or a second memory located externally and generate journal data according to update of the mapping data loaded into the second memory, and in a second operation mode, generate recovered mapping data corresponding to the mapping data loaded into the second memory using the mapping data stored in the first memory or the mapping data and the journal data loaded into the sub memory and control a data movement operation inside the first memory.

In an embodiment of the present disclosure, a computing system may include a host device including a host memory, and configured to output a low power mode control signal; and a storage device including a memory which stores mapping data, and configured to load at least a part of the mapping data into the host memory by accessing the host memory in a normal mode and operate in a low power mode according to the low power mode control signal, wherein in the normal mode, the storage device generates journal data according to update of the mapping data loaded into the host memory, and in the low power mode, the storage device generates recovered mapping data corresponding to the mapping data loaded into the host memory using the mapping data and the journal data stored in the memory and controls a data movement operation inside the memory based on the recovered mapping data.

According to the embodiments of the present disclosure, an unnecessary access between a storage device and a host device may be reduced when switching an operation mode, thereby making it easy to switch the operation mode, and the power consumption of an entire system may be effectively reduced depending on the operation mode.

### BRIEF DESCRIPTION OF THE DRAWINGS

FIG. 1 is a diagram illustrating a schematic configuration of a storage device according to embodiments of the present disclosure.

FIG. 2 is a diagram illustrating a scheme of using mapping data in the operation of the storage device according to the embodiments of the present disclosure.

FIG. 3 is a diagram illustrating a scheme in which the storage device according to the embodiments of the present disclosure sets a segment bitmap according to mapping data associated with a storage block.

FIG. 4 is a diagram illustrating another scheme of using mapping data in the operation of the storage device according to the embodiments of the present disclosure.

FIGS. 5 and 6 are diagrams illustrating a scheme in which the storage device according to the embodiments of the present disclosure manages journal data for mapping data loaded into a host memory.

FIG. 7 is a diagram illustrating a scheme in which the storage device according to the embodiments of the present disclosure switches an operation mode.

FIGS. 8 and 9A to 9E are diagrams illustrating another scheme of using mapping data in the operation of the storage device according to the embodiments of the present disclosure.

FIG. 10 is a diagram illustrating a method for operating a storage device according to embodiments of the present disclosure.

### DETAILED DESCRIPTION

In the following description of embodiments of the present disclosure, reference will be made to the accompanying drawings in which it is shown by way of illustration specific embodiments that can be implemented, and in which the same reference numerals and signs can be used to designate the same or like components even when they are shown in different accompanying drawings from one another. Further, in the following description of embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the present disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can.”

Hereinafter, various embodiments of the present disclosure will be described in detail with reference to accompanying drawings.

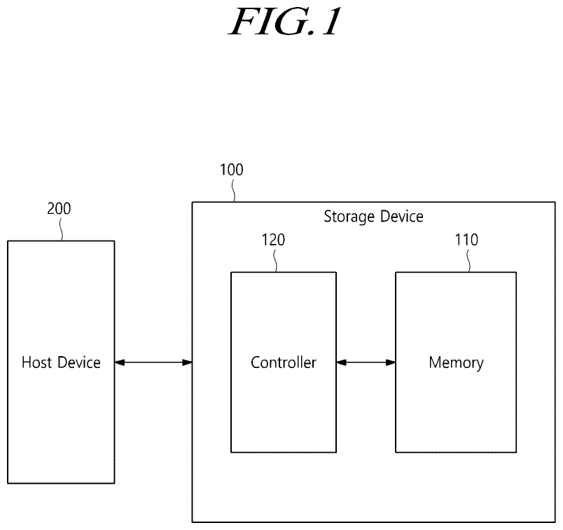

FIG. 1 is a diagram illustrating a schematic configuration of a storage device 100 according to embodiments of the present disclosure.

Referring to FIG. 1, the storage device 100 according to the embodiments of the present disclosure may include at least one memory 110. The storage device 100 may include a controller 120 which controls the operation of the memory 110.

The memory 110 may be, for example, volatile memory such as DRAM, SDRAM, DDR SDRAM and LPDDR SDRAM, but the embodiments of the present disclosure are not limited thereto. The memory 110 may be nonvolatile memory such as NAND flash memory, 3D NAND flash memory and NOR flash memory. As the case may be, one part of the memory 110 included in the storage device 100 may be volatile memory, and the other part may be nonvolatile memory.

In addition, the memory 110 may be one of various types of memory such as resistive RAM, phase change memory, magnetoresistive memory, ferroelectric memory and spin transfer torque memory. As the case may be, the memory 110 may be processing-in-memory which includes a calculation function or a data processing function.

The memory 110 may include a plurality of memory cells which store data. For example, the memory cell may be a single-level cell which stores 1-bit data. Alternatively, the memory cell may be a multi-level cell which stores 2-bit data or a triple-level cell which stores 3-bit data. The memory cell may also store 4 or more-bit data, or may operate as the type of the memory cell it is changed to. For example, the memory cell may store data while operating as a single-level cell, or the same memory cell may store data while operating as a triple-level cell. At least two memory cells may constitute a unit storage region such as one page.

The controller 120 may receive a command from the outside, and may control the operation of the memory 110 based on the received command. In addition, the controller 120 may control the operation of the memory 110 based on an internally generated command. In the present specification, a command which the controller 120 receives from the outside may be referred to as an external command, and a command which is generated inside the controller 120 may be referred to as an internal command.

The controller 120 may control the operation of the memory 110 based on the external command or the internal command. For example, the controller 120 may control an operation of writing data to the memory 110. The controller 120 may control an operation of reading data written to the memory 110. Data may be transmitted and received between the controller 120 and the memory 110.

Depending on the type of the memory 110, the controller 120 may control a data preservation operation (e.g., a refresh operation or a patrol scrub operation) or an erase operation on data written to the memory 110.

In order to maintain and improve the operation performance of the storage device 100. the controller 120 may perform a background operation associated with the memory 110 based on an external command received from an external host device 200 or based on an internal command.

The background operation may include, for example, at least one among garbage collection, wear leveling, read reclaim and bad block management operations. Through control of the background operation, the controller 120 may improve the operation performance of the storage device 100 or prevent the operation performance from deteriorating.

The controller 120 may control the operation of the memory 110 based on a command received from the host device 200. The controller 120 may provide the host device 200 with a processing result according to an operation corresponding to the command. The controller 120 may transmit data or a response signal to the host device 200.

For example, the host device 200 may be a computer, an ultra mobile PC (UMPC), a workstation, a personal digital assistant (PDA), a tablet, a mobile phone, a smartphone, an e-book, a portable multimedia player (PMP), a portable game player, a navigation device, a black box, a digital camera, a digital multimedia broadcasting (DMB) player, a smart television, a digital audio recorder, a digital audio player, a digital picture recorder, a digital picture player, a digital video recorder, a digital video player, a storage configuring a data center, one of various electronic devices configuring a home network, one of various electronic devices configuring a telematics network, an RFID (radio frequency identification) device, a mobility device (e.g., a vehicle, a robot or a drone) capable of traveling under human control or autonomous driving, or the like. Alternatively, the host device 200 may be a virtual/augmented reality device which provides a 2D or 3D virtual reality image or augmented reality image. Besides, the host device 200 may be any of various electronic devices each of which requires a storage device 100 capable of storing data.

The host device 200 may include at least one operating system. The operating system may manage and control overall functions and operations of the host device 200, and may control an interoperation between the host device 200 and the storage device 100. The operating system may be classified into a general operating system and a mobile operating system depending on the mobility of the host device 200.

The controller 120 and the host device 200 may be devices which are separated from each other. As the case may be, the controller 120 and the host device 200 may be implemented by being incorporated as one device. Alternatively, a partial configuration or function of the controller 120 may be implemented by being included in the host device 200. Hereunder, for convenience, the controller 120 and the host device 200 are devices which are separated from each other however, in other embodiments the controller 120 and the host device may be combined.

The storage device 100 may further include working memory to provide a buffer which is used when the controller 120 controls an operation.

The working memory may be, for example, volatile memory such as SRAM and DRAM, but is not limited thereto. As the case may be, the working memory may be located outside the controller 120 or may be located inside the controller 120.

The controller 120 may control various operations of the memory 110 using the working memory. For example, the controller 120 may load, from the memory 110 into the working memory, mapping data representing a correspondence relationship between a logical address (or a logical block address or a logical page number) and a physical address (or a physical block address or a virtual page number), and then, may perform a write operation or a read operation.

As the case may be, the controller 120 may perform control by loading entire mapping data from the host memory 210 into the working memory or may perform control by loading only a part of mapping data from the host memory 210 into the working memory.

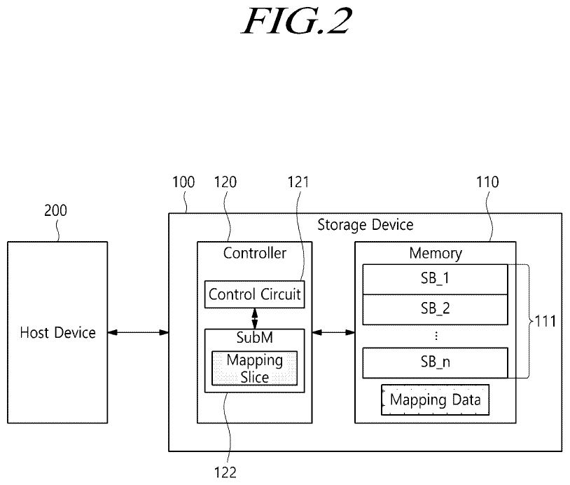

FIG. 2 is a diagram illustrating a scheme of using mapping data in the operation of the storage device 100 according to the embodiments of the present disclosure.

Referring to FIG. 2, the memory 110 of the storage device 100 may include a plurality of storage blocks 111. Each of the plurality of storage blocks 111 may include a plurality of memory cells. At least two memory cells included in each of the plurality of storage blocks 111 may constitute one page as a unit of storing or reading data. Each of the plurality of storage blocks 111 may include a plurality of pages.

The storage block 111 may store user data according to a request from the host device 200. Some of the storage blocks 111 may store metadata including various information used for the operation of the memory 110. Alternatively, metadata may be stored in a storage region separate from the storage blocks 111 which store user data. FIG. 2 illustrates, as an embodiment, a case where the memory 110 includes n number of storage blocks 111 SBb 1, SB_2, . . . , SB_n and mapping data, which is a type of metadata, is stored in a storage region other than the storage blocks 111.

The mapping data may include information on the mapping relationship between a logical address for the host device 200 and a physical address for the memory 110. While control is performed according to a write operation or a read operation, mapping data may be updated or used.

For example, the controller 120 may load mapping data from the memory 110 into working memory and use the mapping data when performing control for various operations.

For example, the controller 120 may load mapping data from the memory 110 into a working memory which is located outside the controller 120. The working memory may be volatile memory such as DRAM, and may have relatively large capacity. In this case, the controller 120 may load the entire mapping data from the memory 110 into the working memory and perform control by using the mapping data.

Alternatively, the controller 120 may load mapping data from the memory 110 into a working memory located inside the controller 120 and perform operation control by using the loaded mapping data. The working memory may be volatile memory, for example, SRAM, and may have small capacity. In this case, the controller 120 may load a part of the mapping data from the memory 110 into the working memory and use the loaded part of the mapping data.

For example, the controller 120 may include a control circuit 121 and a sub memory 122. The control circuit 121 may control the overall operations of the controller 120 and the storage device 100. The sub memory 122 may be the working memory described above. The controller 120 may include at least one sub memory 122 located therein.

The control circuit 121 of the controller 120 may load a part of the mapping data from the memory 110 into the sub memory 122 and perform processing for a command by using the loaded part of the mapping data.

For example, the controller 120 may load a mapping slice corresponding to a part of the mapping data from the memory 110 into the sub memory 122. The mapping slice may include information on the mapping relationship between a logical address for the host device 200 and a physical address for the memory 110. The mapping slice may include partial information of entire mapping data. For example, the mapping slice may include information on physical addresses mapped to some logical addresses among logical addresses by the host device 200.

Since the controller 120 performs control by loading mapping data into the sub memory 122 by the unit of mapping slice, the mapping data may be loaded through the sub memory 122 having a small capacity.

Since the controller 120 loads mapping data into the sub memory 122 by the unit of mapping slice, the controller 120 may separately manage information on mapping slices associated with each storage block 111. For example, the controller 120 may manage information on mapping slices associated with each storage block 111 by using a segment bitmap corresponding to each storage block 111. The segment bitmap may be stored in the sub memory 122. A region of the sub memory 122 may be allocated for the mapping slices, and other region of the sub memory 122 may be allocated for the segment bitmap. In some cases, the controller 120 may store the segment bitmap in the memory 110 for back up.

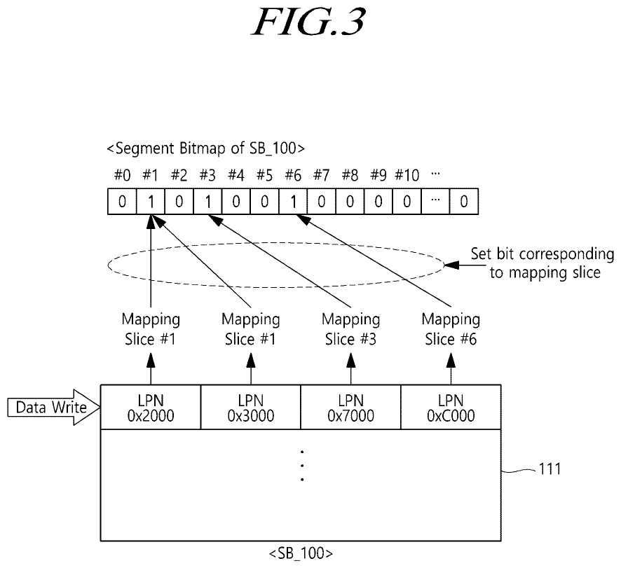

FIG. 3 is a diagram illustrating a scheme in which the storage device 100 according to the embodiments of the present disclosure sets a segment bitmap according to mapping data associated with a storage block 111.

Referring to FIG. 3, the controller 120 may manage a segment bitmap corresponding to each storage block 111. One segment bitmap may be set for each of the plurality of storage blocks 111. As the case may be, one segment bitmap may be set by the unit of at least two storage blocks 111. FIG. 3 illustrates, a scheme in which a segment bitmap corresponding to a storage block SB_100 as a 100th storage block 111 is set.

When writing data to the 100th storage block 111, the controller 120 may update mapping data for the data to be written. The controller 120 may check a mapping slice in which mapping data is updated. The controller 120 may set bit information of the segment bitmap according to the mapping slice in which the mapping data is updated.

For example, data corresponding to a logical address 0x2000 by the host device 200 may be written to the storage block 111. A physical address of the storage block 111 mapped to the logical address 0x2000 may be updated in mapping data, and the logical address 0x2000 may be included in a mapping slice #1, for example. In this case, the controller 120 may set bit information corresponding to the mapping slice #1 in the segment bitmap corresponding to the storage block 111 to a valid value. In the present disclosure, a valid value of the segment bitmap represents that a corresponding mapping slice includes mapping data related to the storage block 111 corresponding to the segment bitmap. In the present disclosure, an invalid value of the segment bitmap represents that a corresponding mapping slice does not include mapping data related to the storage block 111 corresponding to the segment bitmap.

Similarly, as the controller 120 writes data to the storage block 111, the controller 120 may set bit information of the segment bitmap corresponding to a mapping slice which includes mapping information of a logical address for the data to be written.

For example, as data corresponding to logical addresses 0x3000, 0x7000 and 0xC000 are written to the storage block 111, bit information of the segment bitmap for mapping slices #1, #3 and #6 including mapping data for the respective logical addresses 0x3000, 0x7000 and 0xC000 may be set. In the segment bitmap corresponding to the storage block 111, bit information corresponding to the mapping slices #1, #3 and #6 may be set to a valid value. In the segment bitmap, bit information corresponding to mapping slices #0, #2, #4, #5 and #7 to #10 may be set to an invalid value.

The controller 120 may manage, through the segment bitmap, information on a mapping slice including mapping data associated with the storage block 111. The controller 120 may check, through the segment bitmap, a mapping slice including mapping data associated with the corresponding storage block 111. The controller 120 may load the checked mapping slice into the sub memory 122 and use the loaded mapping slice.

For example, when performing a read operation on the corresponding storage block 111, the controller 120 may load the segment bitmap into the sub memory 122 and check bit information of the segment bitmap. The controller 120 may load, into the sub memory 122, the mapping slices #1, #3 and #6 set to the valid value, and perform an operation by using mapping data. Since mapping data is loaded into the sub memory 122 by the unit of mapping slice, mapping data may be loaded through the sub memory 122 of small capacity, and operation control may be performed by using the mapping data.

In addition, as the case may be, the controller 120 may use a storage region located outside the storage device 100 as a region for loading mapping data.

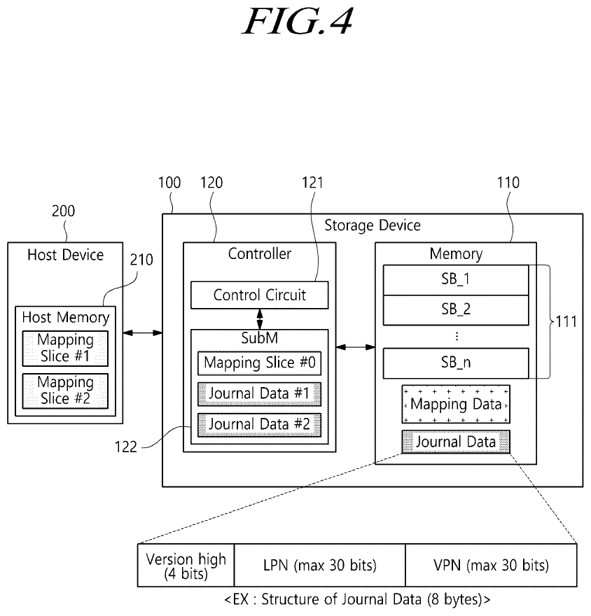

FIG. 4 is a diagram illustrating another scheme of using mapping data in the operation of the storage device 100 according to the embodiments of the present disclosure.

Referring to FIG. 4, the controller 120 of the storage device 100 may include a control circuit 121 and a sub memory 122. The controller 120 may load mapping data into the sub memory 122, and may perform operation control by using the mapping data.

The controller 120 may use a storage region located outside the storage device 100 to load mapping data.

For example, the host device 200 may include a host memory 210. The host memory 210 may be volatile memory such as DRAM. The host device 200 may perform data processing by using the host memory 210.

The host device 200 may allocate a partial region of the host memory 210 to the storage device 100. The storage device 100 may be allocated the partial region of the host memory 210 and use the allocated storage region like working memory.

For example, the controller 120 of the storage device 100 may load mapping data into the host memory 210. The controller 120 may load mapping data into the sub memory 122 located internally and the host memory 210 located externally and may perform operation control by using the mapping data.

Mapping data may be located in the memory 110, the sub memory 122 and the host memory 210. As the size of mapping data to be loaded into the sub memory 122 and the host memory 210 increases, data processing performance by using the mapping data may be improved. In the present specification, among the storage regions located outside the controller 120, the memory 110 may be referred to as a first memory, and the host memory 210 may be referred to as a second memory.

The controller 120 may load mapping data by the unit of mapping slice. As in the embodiment illustrated in FIG. 4, the controller 120 may load a mapping slice #0 into the sub memory 122 for operation control. The controller 120 may load mapping slices #1 and #2 into the host memory 210. The case illustrated in FIG. 4 represents an example, and the controller 120 may load a mapping slice by using a region allocated for loading mapping data in the sub memory 122 and a region allocated for the storage device 100 in the host memory 210 and may perform data processing by using the mapping slice.

The controller 120 may generate and manage journal data for mapping data loaded into the host memory 210.

For example, the controller 120 may load the mapping slices #1 and #2 into the host memory 210 and perform operation control. As data processing for logical addresses associated with the mapping slices #1 and #2 is performed, mapping data included in the mapping slices #1 and #2 may be updated. The controller 120 may generate journal data #1 and #2 for the mapping slices #1 and #2.

The controller 120 may store generated journal data in a region allocated for journal data in the sub memory 122. Journal data may include version information of corresponding data, a logical page number which is a logical address for the host device 200, and a virtual page number which is a physical address for the memory 110.

When the region allocated for journal data in the sub memory 122 is full or generated journal data is equal to or larger than a predetermined size, the controller 120 may store journal data in the memory 110. A region where journal data is stored in the memory 110 may be a region where metadata is stored, such as a region where mapping data is stored, but is not limited thereto.

The controller 120 loads mapping data by using the host memory 210 and separately manages journal data for the mapping data loaded into the host memory 210. Therefore, even in various operating situations, the controller 120 may perform operation control without loss of the mapping data loaded into the host memory 210.

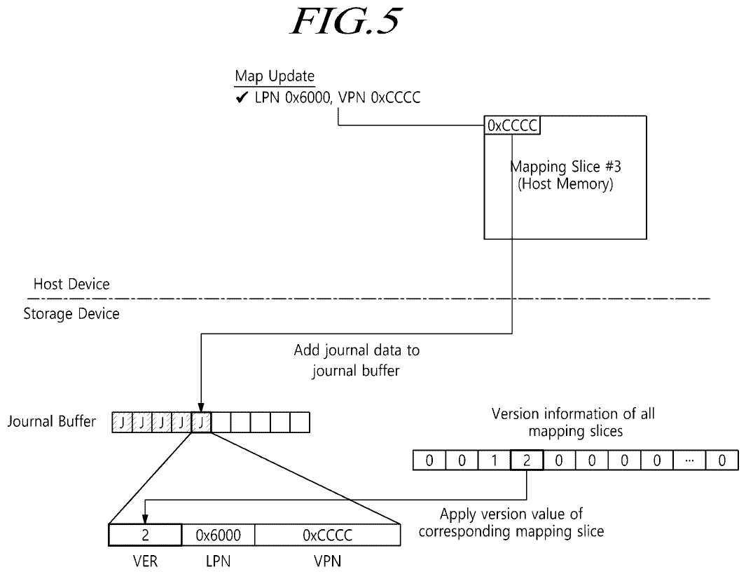

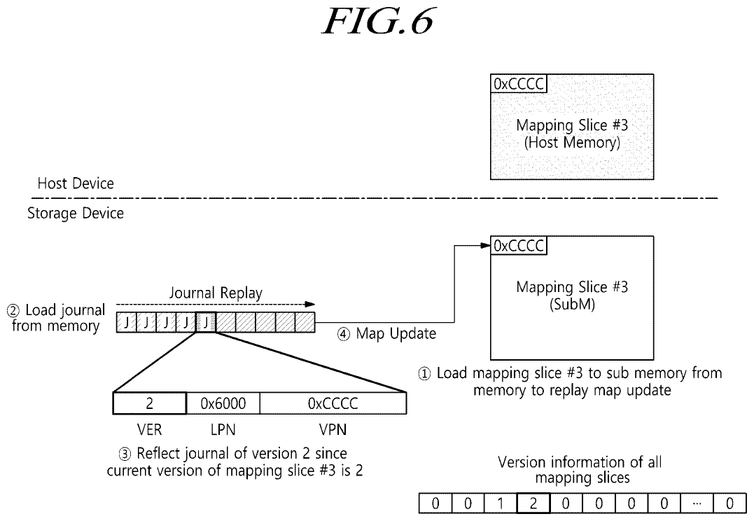

FIGS. 5 and 6 are diagrams illustrating a scheme in which the storage device 100 according to the embodiments of the present disclosure manages journal data for mapping data loaded into the host memory 210. Referring to FIG. 5, a case where a mapping slice #3 is loaded into

the host memory 210 is illustrated. The mapping slice #3 may include mapping information between a logical address 0x6000 and a physical address 0xCCCC. According to update of mapping data included in the mapping slice #3, journal data may be generated in the storage device 100.

The controller 120 may store the generated journal data in a journal buffer region which is allocated for journal data in the sub memory 122. In the sub memory 122, a region where mapping data or a mapping slice is loaded and a region where journal data is stored may be distinguished. The region for a mapping slice may be referred to as a first region, and the region where journal data is stored may be referred to as a second region.

Journal data may include version information of generated journal data and information on a logical address and a physical address. Version information of journal data may be managed for each mapping slice which constitutes mapping data. For example, when mapping data is updated in a mapping slice, the controller 120 may increase version information by 1 for the updated mapping slice. When all mapping slices are stored in the memory 110, the controller 120 may initialize version information of all mapping slices to 0. The version information of the mapping slices may be stored in the sub memory 122. A region of the sub memory 122 may be allocated for the version information of the mapping slices. In some cases, the version information of the mapping slices may be stored in the memory 110 for back up. The version information may be updated by updating the mapping slices. And also, a version information of the journal data corresponding to the mapping slice may be updated according to the update of the version information of the mapping slice.

The controller 120 may manage journal data by using the region of the sub memory 122 for journal data and the region where journal data is stored in the memory 110, and when necessary, may recover mapping data by using journal data.

For example, referring to FIG. 6, a case where the controller 120 recovers the mapping slice #3 loaded into the host memory 210 is illustrated.

In order to recover the mapping slice #3, the controller 120 may load the mapping slice #3 from the memory 110 into the sub memory 122 (\textcircled{1}). The mapping slice #3 loaded into the sub memory 122, as mapping data before the mapping slice #3 loaded into the host memory 210, may correspond to mapping data before update.

The controller 120 may load journal data from the memory 110 into the sub memory 122 (\textcircled{2}). The controller 120 may check version information of the loaded journal data (\textcircled{3}). The controller 120 may check version information of the mapping slice #3 stored in the sub memory 122. When the version information of the journal data corresponds to the version information of the mapping slice #3, the controller 120 may update the mapping slice #3, which is loaded from the memory 110 into the sub memory 122 (\textcircled{1}), based on the loaded journal data (\textcircled{4}).

The controller 120 may recover and use mapping data loaded into the host memory 210 by using mapping data and journal data stored in the memory 110 without accessing the host memory 210.

The controller 120 may perform the recovery operation by using journal data when an error occurs in the host memory 210 and may also perform the recovery operation by using journal data even when the host memory 210 is not accessed depending on an operating situation.

For example, an operation mode may be switched to reduce power consumption. When an operation mode is switched, to minimize access to the host device 200, mapping data may be recovered inside the storage device 100 and operation control may be performed by using recovered mapping data.

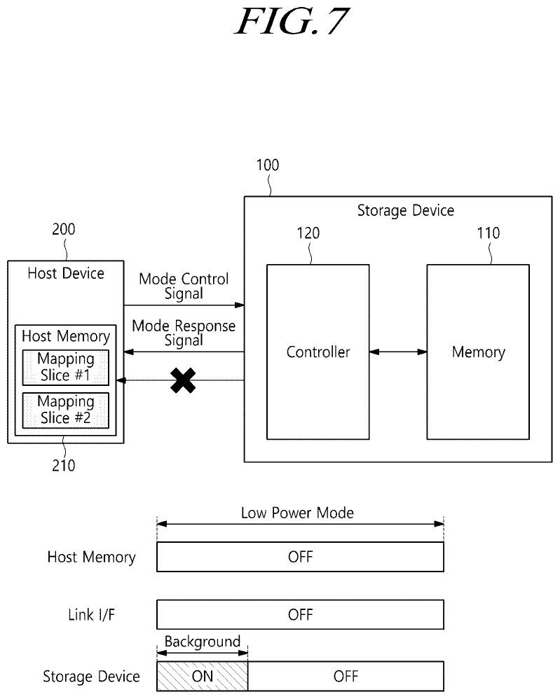

FIG. 7 is a diagram illustrating a scheme in which the storage device 100 according to the embodiments of the present disclosure switches an operation mode.

Referring to FIG. 7, the storage device 100 may receive a mode control signal transmitted by the host device 200 during operation. The mode control signal may be a signal which requests to change the operation mode of the storage device 100. According to the mode control signal, the operation mode of the storage device 100 or a computing system including the storage device 100 and the host device 200 may be changed.

For example, the storage device 100 may operate in a first operation mode. The first operation mode may be referred to as a normal mode or a normal power mode. The storage device 100 may receive the mode control signal transmitted by the host device 200. The storage device 100 may transmit a mode response signal to the host device 200 in response to the mode control signal.

The storage device 100 may operate in a second operation mode according to reception of the mode control signal. The second operation mode may mean a mode in which at least some functions that operate in the first operation mode are prohibited or not performed. For example, in the second operation mode, access to the host device 200 by the storage device 100 may be prohibited. Alternatively, some operations or functions of the storage device 100 and the host device 200 may be stopped.

The second operation mode may be, for example, a low power mode. The storage device 100 and the host device 200 may operate in the low power mode. In this case, the mode control signal may be referred to as a low power mode control signal, and the mode response signal may be referred to as a low power mode response signal.

In the low power mode, to reduce power consumption, the host device 200 may maintain some components in an off state or a state in which only minimal power is supplied. For example, when the low power mode is entered, the host device 200 may maintain the host memory 210 in an off state. After transmitting the mode control signal to the storage device 100, the host device 200 may also maintain, in an off state, a link interface which performs communication with the storage device 100.

The host device 200 may maintain the host memory 210 and the link interface in an off state after transmitting the mode control signal to the storage device 100, or may maintain the host memory 210 and the link interface in an off state after receiving the mode response signal from the storage device 100.

In the low power mode, the storage device 100 may not access the host device 200. In the low power mode, except a case where a command signal generated by the host device 200 is transmitted, communication between the host device 200 and the storage device 100 may be stopped.

Upon receiving the mode control signal from the host device 200, the storage device 100 may maintain also the storage device 100 in an off state in order to reduce power consumption. The storage device 100 may become an off state as the storage device 100 enters the low power mode according to reception of the mode control signal or transmission of the mode response signal. Alternatively, the storage device 100 may become an off state after internally performing a necessary operation before entering the low power mode.

For example, the storage device 100 may perform a necessary background operation before entering the low power mode. The storage device 100 may enter the low power mode after performing the background operation.

The background operation performed by the storage device 100 may be various, and a background operation in which a data movement operation is performed inside the memory 110 may be performed. The storage device 100 may control the data movement operation by using mapping data inside the memory 110.

When mapping data loaded into the host memory 210 is required for the data movement operation before switching of the operation mode, the storage device 100 may control the data movement operation by using mapping data inside the memory 110. The storage device 100 may control the data movement operation based on the mapping data loaded into the host memory 210 without accessing the host memory 210.

For example, in the first operation mode, mapping slices #1 and #2 may be loaded into the host memory 210 by the storage device 100. According to the mode control signal of the host device 200, the storage device 100 and the host device 200 may enter the low power mode.

Upon receiving the mode control signal or transmitting the mode response signal, the storage device 100 may not access the host memory 210.

The storage device 100 may control a background operation based on the mapping slices #1 and #2 loaded into the host memory 210 in the first operation mode without accessing the host memory 210. Since a time point at which the host device 200 enters the low power mode may be advanced, power consumption may be reduced.

Since the storage device 100 performs the background operation by using internal mapping data, the storage device 100 may perform the background operation and become an off state without delay according to reception of associated data from the host memory 210.

When mapping data loaded into the host memory 210 is required before entering the second operation mode, the storage device 100 may generate recovered mapping data by using existing mapping data stored in the memory 110 and journal data managed in association with the mapping data loaded into the host memory 210.

The storage device 100 may perform the data movement operation based on the recovered mapping data.

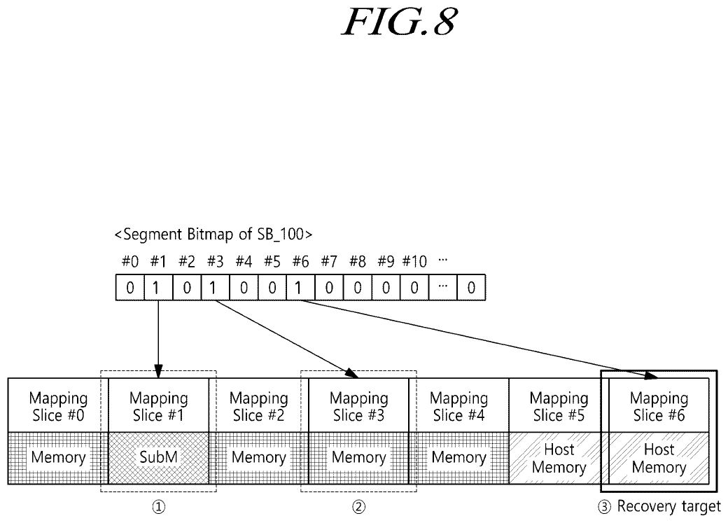

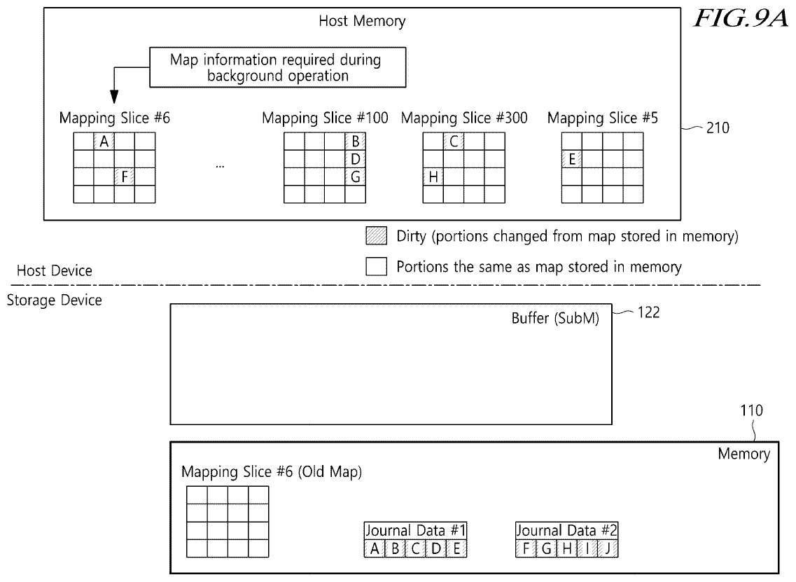

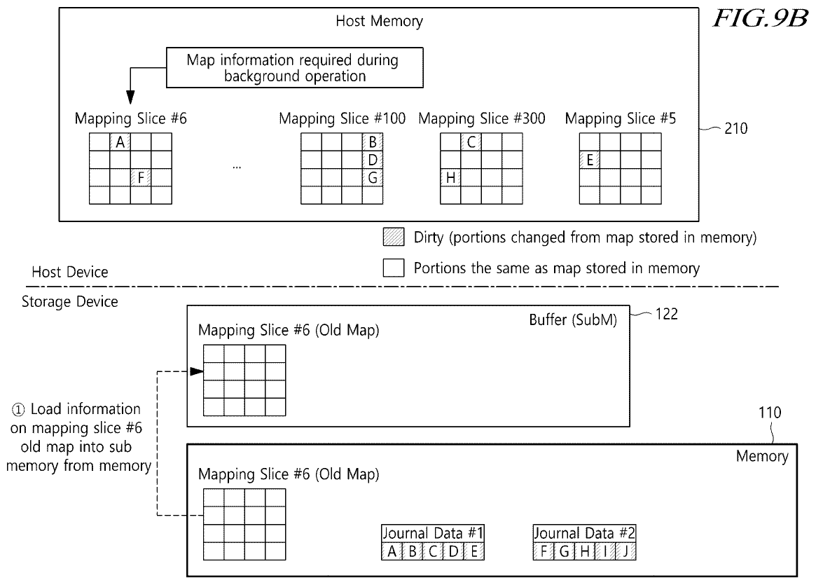

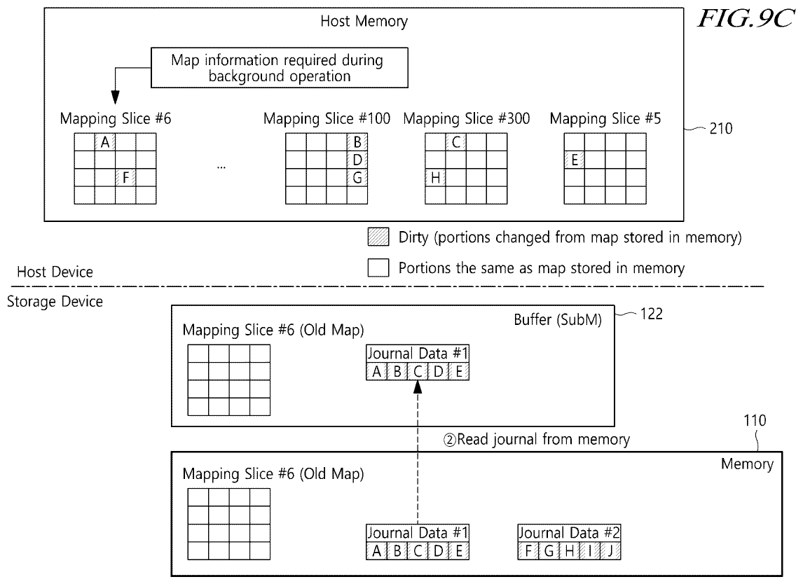

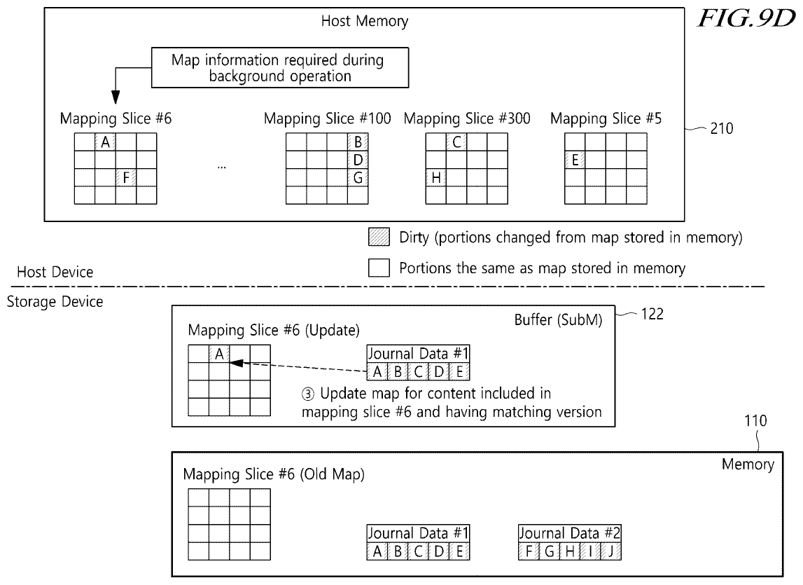

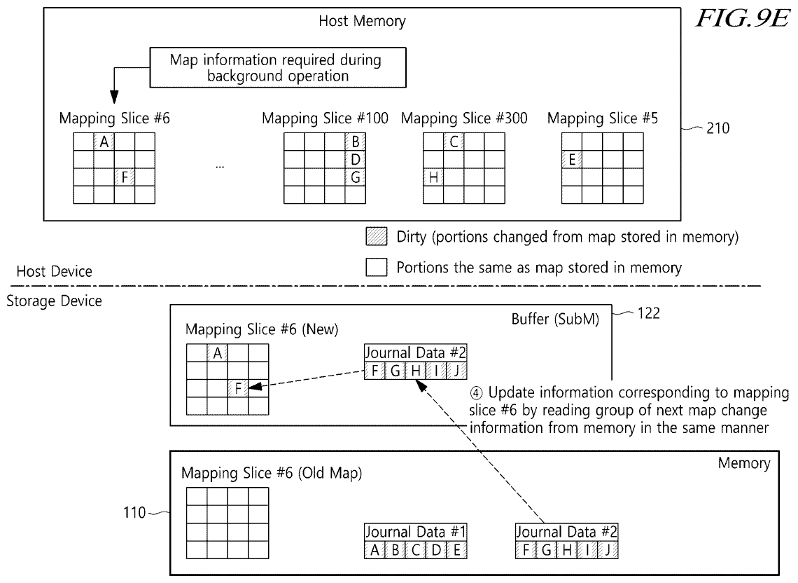

FIGS. 8 and 9A to 9E are diagrams illustrating another scheme of using mapping data in the operation of the storage device 100 according to the embodiments of the present disclosure.

Referring to FIG. 8, a scheme in which the storage device 100 uses mapping data to perform a data movement operation according to a background operation without accessing the host memory 210 in the second operation mode is illustrated.

For example, the controller 120 of the storage device 100 may check mapping data for a victim storage block as a target of data movement among the plurality of storage blocks 111 included in the memory 110, and may control the data movement operation based on the mapping data.

When the victim storage block is, for example, a 100th storage block 111 SB_100, the controller 120 may check a segment bitmap corresponding to the 100th storage block 111 SB_100. The controller 120 may check bit information of the segment bitmap, and may check the storage location of a mapping slice whose bit information has a valid value.

The controller 120 may check, through the bit information of the segment bitmap, that a mapping slice #1 includes mapping data for the 100th storage block 111 SB_100. The controller 120 may manage a location where a mapping slice is stored and may check that the mapping slice #1 is stored in the sub memory 122. The mapping data may be stored in the memory 110. The controller 120 may load the mapping slice which is a part of the mapping data in the sub memory 122. In some cases, the controller 120 may load the mapping slice in the host memory 210. Thus, the controller 120 may check the location of the mapping slice.

As in \textcircled{1}, in a case where the mapping slice #1 associated with the victim storage block is stored in the sub memory 122, the controller 120 may perform the data movement operation based on the mapping slice #1 stored in the sub memory 122.

Similarly, the controller 120 may check, through the bit information of the segment bitmap, that a mapping slice #3 includes mapping data for the 100th storage block 111 SB_100.

As in \textcircled{2}, since the mapping slice #3 associated with the victim storage block is stored in the memory 110, the controller 120 may load the mapping slice #3 stored in the memory 110 into the sub memory 122. The controller 120 may perform the data movement operation by using the mapping slice #3 loaded into the sub memory 122.

The controller 120 may check, through the bit information of the segment bitmap, that a mapping slice #6 includes mapping data for the 100th storage block 111 SB_100 being the victim storage block.

As in \textcircled{3}, the controller 120 may check that the mapping slice #6 associated with the victim storage block is stored in the host memory 210. Since the controller 120 cannot access the host memory 210, the controller 120 may generate recovered mapping data corresponding to the mapping slice #6 loaded into the host memory 210 by using mapping data and journal data inside the storage device 100.

As illustrated in FIG. 8, it may be a state in which a mapping slice #5 and the mapping slice #6 are loaded into the host memory 210. Since the bit information of the segment bitmap for the mapping slice #5 has an invalid value, the controller 120 may not perform recovery for the mapping slice #5.

The controller 120 may selectively perform recovery for only the mapping slice #6 indicated by valid bit information.

Since the controller 120 controls the data movement operation while selectively performing recovery for only mapping data required for the data movement operation according to the background operation, the controller 120 may complete the data movement operation while not accessing the host memory 210 and minimizing delay, and then, may enter an off state.

The controller 120 may generate the recovered mapping data by sequentially loading existing mapping data and journal data into the sub memory 122. For example, the mapping slice #6 which is stored in the memory 110 and is not updated may be loaded in the sub memory 122.

And the journal data related to the mapping slice #6 may be loaded from the memory 110 to the sub memory 122. In some cases, the journal data related to the mapping slice #6 may be already stored in the sub memory 122.

For example, referring to FIG. 9A, a state in which a plurality of mapping slices are loaded into the host memory 210 by the controller 120 in the first operation mode is illustrated. As illustrated in FIG. 9A, mapping slices #6, #100, #300, #5, etc. may be loaded into the host memory 210. In the first operation mode, the controller 120 performs an operation according to a command by using a mapping slice loaded into the host memory 210, and thus, the update of the mapping slice loaded into the host memory 210 may occur according to a write operation or the like.

Due to the update of the mapping slice loaded into the host memory 210, the mapping slice loaded into the host memory 210 may become different from the mapping slice stored in the memory 110. The controller 120 may generate journal data according to the update of the mapping slice loaded into the host memory 210 and store and manage the journal data in the memory 110.

The controller 120 may perform the data movement operation according to the background operation after entering the second operation mode. As described above with reference to FIG. 8, among the mapping slices loaded into the host memory 210, the mapping slice #6 may be required for the data movement operation. The controller 120 may generate recovered mapping data corresponding to the mapping slice #6 loaded into the host memory 210.

For example, referring to FIG. 9B, the controller 120 may load a mapping slice #6 from the memory 110 into the sub memory 122 (\textcircled{1}). The mapping slice #6 from the memory 110 may include mapping data before the mapping slice #6 is loaded into the host memory 210 and is updated. The controller 120 may load the mapping slice #6 into the first region of the sub memory 122.

After loading a mapping slice as a recovery target into the sub memory 122, the controller 120 may load journal data to be used for recovery into the sub memory 122.

For example, referring to FIG. 9C, a case where journal data #1 and journal data #2 are stored in the memory 110 is illustrated.

The controller 120 may load, among journal data stored in the memory 110, the journal data #1 into the second region of the sub memory 122 (\textcircled{2}). As the case may be, it may be a state in which journal data is stored in the second region of the sub memory 122, and in this case, the controller 120 may perform the recovery operation by using the journal data already loaded into the sub memory 122.

In order for recovery of the mapping slice #6, the controller 120 may sequentially load all of the journal data from the memory 110 into the sub memory 122 and perform a recovery operation based on the journal data. For example, journal data may be stored in the order in which they are generated. Since the controller 120 cannot accurately check a location where journal data associated with the mapping slice #6 as a recovery target is stored, the controller 120 may perform the recovery operation by sequentially loading all of the journal data from the memory 110 into the sub memory 122. In some cases, the controller 120 may check the version information of the journal data and load the journal data which is updated last.

The controller 120 may perform the recovery operation based on the journal data #1 loaded into the sub memory 122.

For example, referring to FIG. 9D, the controller 120 may sequentially check journal data A, B, C, D and E included in the journal data #1. Journal data #1 may mean a group of several journal data related to each mapping data. The controller 120 may check that among the journal data A, B, C, D and E included in the journal data #1, the journal data A is associated with the mapping slice #6.

The controller 120 may check the version information of the mapping slice #6 and the version information of the journal data A. When the version information of the mapping slice #6 and the version information of the journal data A are the same, the controller 120 may update the mapping slice #6 based on the journal data A (\textcircled{3}). When the version information of the mapping slice #6 and the version information of the journal data A are not the same, the controller 120 may not perform update according to the journal data A. The mapping slice #6, which is currently stored in the memory 110, may keep its data (i.e., the logical address LPN and physical address VPN) as stored in the memory 110.

When the recovery operation based on the journal data #1 is completed, the controller 120 may perform an operation for recovery of the mapping slice #6 by sequentially loading remaining journal data into the sub memory 122.

For example, referring to FIG. 9E, the controller 120 may load the journal data #2 from the memory 110 into the sub memory 122.

The controller 120 may sequentially check journal data F, G, H, I and J included in the journal data #2. The controller 120 may update the mapping slice #6 based on the journal data F associated with the mapping slice #6 among the journal data included in the journal data #2 (\textcircled{4}).

In a state in which the mapping slice #6 as a recovery target is loaded into the sub memory 122, the controller 120 may perform the recovery operation by sequentially loading all journal data from the memory 110 into the sub memory 122. In some cases, if two or more journal data including a same logical address exist, the controller 120 may load the journal data which includes latest version information.,

When the recovery operation based on all journal data is completed, the controller 120 may generate a finally updated mapping slice #6 as the recovered mapping data. The controller 120 may control the data movement operation for the victim storage block associated with the mapping data of the mapping slice #6 based on the recovered mapping data.

The controller 120 may selectively perform recovery for a mapping slice which requires recovery according to the data movement operation. When performing a data movement operation for another victim storage block after generation of recovered mapping data is completed, the controller 120 may perform the data movement operation by using the recovered mapping data.

For example, the controller 120 may perform a data movement operation for another victim storage block by using the mapping slice #6 corresponding to the recovered mapping data.

Since the controller 120 performs a data movement operation while selectively recovering mapping data, it is possible to perform a data movement operation based on mapping data loaded into the host memory 210 without accessing the host memory 210. The data movement operation according to the background operation may be completed while minimizing delay upon mode switching. Entry to a low power mode may be facilitated, and unnecessary delay by a background operation when entering the low power mode may be reduced.

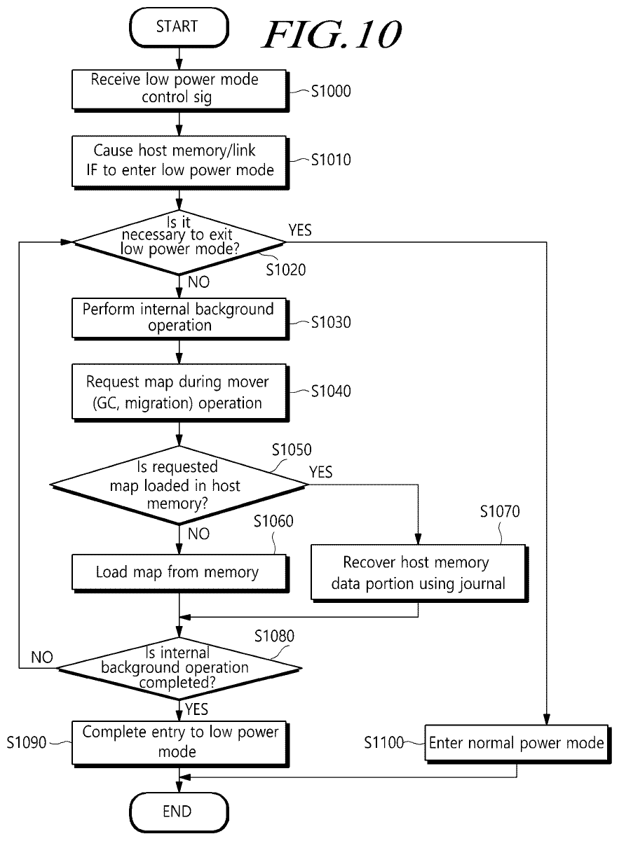

FIG. 10 is a diagram illustrating a method for operating the storage device 100 according to embodiments of the present disclosure.

Referring to FIG. 10, the storage device 100 may receive a low power mode control signal from the host device 200 (S1000). After transmitting the low power mode control signal, the host device 200 may cause the host memory 210 and a link interface to enter a low power mode (S1010).

The host device 200 may also control some other components or functions to operate according to the low power mode. As the case may be, the host device 200 may enter the low power mode after receiving a low power mode response signal from the storage device 100.

The storage device 100 and the host device 200 may monitor whether to maintain the low power mode or the necessity of the low power mode, and when it is a situation where it is necessary to exit the low power mode (“YES” of S1020), the storage device 100 and the host device 200 may enter a normal power mode according to a request from the host device 200 (S1100).

When it is a situation where the low power mode may be maintained (“NO” of S1020), the storage device 100 may perform a necessary background operation before entering an off state (S1030).

The storage device 100 may perform a data movement operation according to the background operation (S1040). A request for mapping data may be generated according to the data movement operation.

The storage device 100 may check whether the mapping data as a request target is mapping data which is loaded into the host memory 210

(S1050). When the requested mapping data is not loaded into the host memory 210 (“NO” of S1050), the storage device 100 may load the corresponding mapping data into the sub memory 122 from the memory 110 (S1060). As the case may be, it may be a state in which the requested mapping data is loaded into the sub memory 122.

When the requested mapping data is loaded into the host memory 210 (“YES” of S1050), the storage device 100 may generate recovered mapping data corresponding to the mapping data loaded into the host memory 210 by using existing mapping data and journal data stored in the memory 110 (S1070). The storage device 100 may generate the necessary recovered mapping data without accessing the host memory 210.

The storage device 100 may complete the background operation by using the recovered mapping data generated according to the mapping data and the journal data loaded from the memory 110 (S1080). When the background operation is not completed (“NO” of S1080),

the storage device 100 may operate to perform a necessary background operation and check whether to maintain the low power mode. Generation of additionally necessary recovered mapping data may be performed, and generated recovered mapping data may be used in another data movement operation.

When the background operation is completed (“YES” of S1080), the storage device 100 may enter the off state and operate according to the low power mode (S1090). In the low power mode, access to the host device 200 by the storage device 100 may be prohibited, and if necessary, communication between the host device 200 and the storage device 100 may be resumed according to a command signal by the host device 200.

According to the embodiments of the present disclosure, since the storage device 100 loads mapping data and performs data processing by using the host memory 210 of the host device 200, it is possible to reduce decreases in data processing performance even when the capacity of the working memory of the storage device 100 is small.

In addition, in an operation mode that prohibits access between the host device 200 and the storage device 100 to reduce power consumption, etc., mapping data required for an internal background operation of the storage device 100 may be recovered by using journal data inside the storage device 100. Accordingly, a time point at which access between the host device 200 and the storage device 100 is stopped may be advanced.

While enabling the storage device 100 to use the host memory 210 of the host device 200, switching of an operation mode may be facilitated, whereby it is possible to reduce power consumption and improve operational performance of a computing system including the host device 200 and the storage device 100.

Although various embodiments of the present disclosure have been described with particular specifics and varying details for illustrative purposes, those skilled in the art will appreciate that various modifications, additions and substitutions may be made based on what is disclosed or Illustrated in the present disclosure without departing from the spirit and scope of the present disclosure as defined in the following claims. Furthermore, the embodiments may be combined to form additional embodiments.

What is claimed is:

1. A storage device comprising:
a memory including a plurality of storage blocks and configured to store therein mapping data representing a correspondence relationship between a logical address for a host device and a physical address for a storage area within the plurality of storage blocks; and
a controller configured to:
in a first operation mode, load at least a part of the mapping data into a host memory located in the host device, and generate journal data according to update of the mapping data loaded into the host memory, and
in a second operation mode, generate recovered mapping data corresponding to the mapping data loaded into the host memory by using the mapping data and the journal data stored in the memory, and control a data movement operation to be performed inside the memory based on the recovered mapping data.

2. The storage device according to claim 1,
wherein the mapping data includes one or more mapping slices,
wherein the controller loads the part by loading at least some of the mapping slices into the host memory, and
wherein the controller generates the recovered mapping data and controls the data movement operation when the second operation mode is entered in a state that a mapping slice associated with a victim storage block, which is a target of the data movement operation among the plurality of storage blocks, is loaded into the host memory.

3. The storage device according to claim 2, wherein the controller generates the recovered mapping data when version information of the journal data is the same as version information of the mapping slice associated with the victim storage block.

4. The storage device according to claim 2, wherein the controller generates the recovered mapping data based on the mapping slice associated with the victim storage block when version information of the journal data is different from version information of the mapping slice associated with the victim storage block.

5. The storage device according to claim 2,
further comprising a sub memory,
wherein the controller generates the recovered mapping data by:
loading, from the memory, the mapping slice associated with the victim storage block into a first region of the sub memory,
sequentially loading, from the memory, the journal data into a second region of the sub memory, and
generating the recovered mapping data by updating, based on the journal data loaded into the second region, the mapping slice loaded into the first region.

6. The storage device according to claim 5, wherein the controller generates the recovered mapping data by:
loading, from the memory, a first mapping slice associated with the victim storage block into the first region,
sequentially loading, from the memory, all journal data into the second region,
generating first recovered mapping data by updating, based on the journal data loaded into the second region, the first mapping slice loaded into the first region,
loading, from the memory, a second mapping slice associated with the victim storage block into the first region,
sequentially loading, from the memory, all journal data into the second region, and
generating second recovered mapping data by updating, based on the journal data loaded into the second region, the second mapping slice loaded into the first region.

7. The storage device according to claim 2, wherein the controller is further configured to identify, among the mapping slices associated with the victim storage block, a mapping slice as a target of generating the recovered mapping data according to a segment bitmap, which includes information indicating whether each of the mapping slices associated with the victim storage block is valid.

8. The storage device according to claim 7, wherein the controller generates the recovered mapping data for the mapping slice, which is associated with the victim storage block and indicated as valid by the segment bitmap.

9. The storage device according to claim 7, wherein the controller skips operation to generate the recovered mapping data for a mapping slice which is indicated as being invalid by the segment bitmap and is loaded into the host memory.

10. The storage device according to claim 1, wherein the controller is further configured to:
receive a mode control signal from the host device in the first operation mode,
transmit a mode response signal to the host device in response to the mode control signal, and
stop accessing the host memory after transmitting the mode response signal.

11. The storage device according to claim 10, wherein the controller generates the recovered mapping data after transmitting the mode response signal and stops accessing the host memory while performing the data movement operation.

12. The storage device according to claim 10, wherein the controller stops accessing the host memory after transmitting the mode response signal except in a case where a command signal by the host device is generated.

13. A controller comprising:
a sub memory; and
a control circuit configured to:
in a first operation mode, load mapping data from a first memory, which is located externally, into the sub memory or a second memory, which is located externally, and generate journal data according to update of the mapping data loaded into the second memory, and
in a second operation mode, generate, by using the mapping data stored in the first memory or the journal data and the mapping data loaded into the sub memory, recovered mapping data corresponding to the mapping data loaded into the second memory, and control a data movement operation inside the first memory on the basis of the recovered mapping data.

14. The controller according to claim 13,
wherein the mapping data includes one or more mapping slices, and
wherein the control circuit loads the mapping data by loading at least some of the mapping slices from the first memory into the second memory.

15. The controller according to claim 14,
wherein the control circuit generates the recovered mapping data when the second operation mode is entered in a state that a mapping slice associated with the data movement operation is loaded into the second memory, and
wherein the control circuit generates the recovered mapping data by loading, from the first memory into the sub memory, the mapping slice associated with the data movement operation and the journal data.

16. The controller according to claim 15, wherein the control circuit generates the recovered mapping data by:
loading, from the first memory into the sub memory, the mapping slice associated with the data movement operation,
sequentially loading, from the first memory into the sub memory, all journal data, and
generating the recovered mapping data by updating, based on the journal data loaded into the sub memory, the mapping slice associated with the data movement operation and loaded into the sub memory.

17. The controller according to claim 16, wherein the control circuit stops accessing the second memory while, in the second operation mode, generating the recovered mapping data and controlling the data movement operation based on the recovered mapping data.

18. A computing system comprising:
a host device including a host memory and configured to output a low power mode control signal; and
a storage device including a memory configured to store therein mapping data, the storage device being configured to load at least a part of the mapping data into the host memory in a normal mode and operate in a low power mode according to the low power mode control signal,
wherein the storage device is further configured to:
in the normal mode, generate journal data according to update of the mapping data loaded into the host memory, and
in the low power mode, generate recovered mapping data corresponding to the mapping data loaded into the host memory by using the mapping data and the journal data stored in the memory and control a data movement operation inside the memory based on the recovered mapping data.

19. The computing system according to claim 18, wherein upon receiving the low power mode control signal, the storage device transmits a low power mode response signal to the host device and stops accessing the host memory.

20. The computing system according to claim 18, wherein while generating the recovered mapping data and controlling the data movement operation in the low power mode, the storage device stops accessing the host memory except in a case where a command signal by the host device is generated.
